(19) United States
(12) Patent Application Publication
(10) Pub. No.: US 2015/0012471 A1
(43) Pub. Date: Jan. 8, 2015

(54) SYSTEM FOR USER PSYCHOSOCIAL PROFILING

(71) Applicant: SenseGon Technologies Ltd., Ra'anana (IL)

(72) Inventors: Omer EFRAT, Tel Aviv (IL); Tal Yaari, Bnei-Brak (IL)

(21) Appl. No.: 13/933,270

(22) Filed: Jul. 2, 2013

(51) Int. Cl. G06N 3/02

(52) U.S. Cl. CPC G06N 3/02
USPC 706/15

(57) ABSTRACT

A profiling unit is provided herein. The profiling unit comprises a statistical module that characterizes user activity data statistically; a normalization module that normalizes the statistical data related to each user with respect to user populations; and an analysis unit that analyzes a correspondence between normalized user study data and user archetypes, and also associates, for each user, the normalized statistical data with one of the user archetypes according to the analyzed correspondence. The correspondence analysis is carried out by applying a heuristic genetic algorithm on an artificial neural network that represents the relation between the normalized user study data and the user archetypes.

### BACKGROUND OF THE INVENTION

1. Technical Field

The present invention relates to the field of user profiling, and more particularly, to user profiling by integrated statistics and experimental studies.

2. Discussion of Related Art Internet resources such as social networks and forums attract evermore users to intensively interact with each other. Potentially, these interactions may be used to characterize and profile the users, but appropriate and effective methods are largely missing.

### SUMMARY OF THE INVENTION

One aspect of the present invention provides a profiling unit comprising: a statistical module arranged to receive user activity data and derive therefrom a plurality of statistical data that characterize the user activity data with respect to a plurality of users; a normalization module arranged to normalize the statistical data related to each user with respect to at least one user population; and an analysis unit arranged to analyze a correspondence between a plurality of normalized user study data and a plurality of user archetypes, and to associate, for each user, the normalized statistical data with one of the user archetypes according to the analyzed correspondence. The correspondence analysis is carried out by applying a heuristic genetic algorithm on an artificial neural network that represents the relation between the normalized user study data and the user archetypes.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1 and 3 are high level schematic block diagrams illustrating a profiling system according to some embodiments of the invention,

FIG. 2 is a high level schematic illustration of the information flow through a profiling system according to some embodiments of the invention,

FIG. 4 is a high level schematic illustration of a profiling system according to some embodiments of the invention,

FIG. 5 is a high level schematic flowchart illustrating a formalization of information flow through a profiling system according to some embodiments of the invention,

FIG. 6 is a high level schematic illustration of a profiling system according to some embodiments of the invention, and

FIG. 7 is a high level schematic flowchart of a profiling method according to some embodiments of the invention.

### DETAILED DESCRIPTION OF THE INVENTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

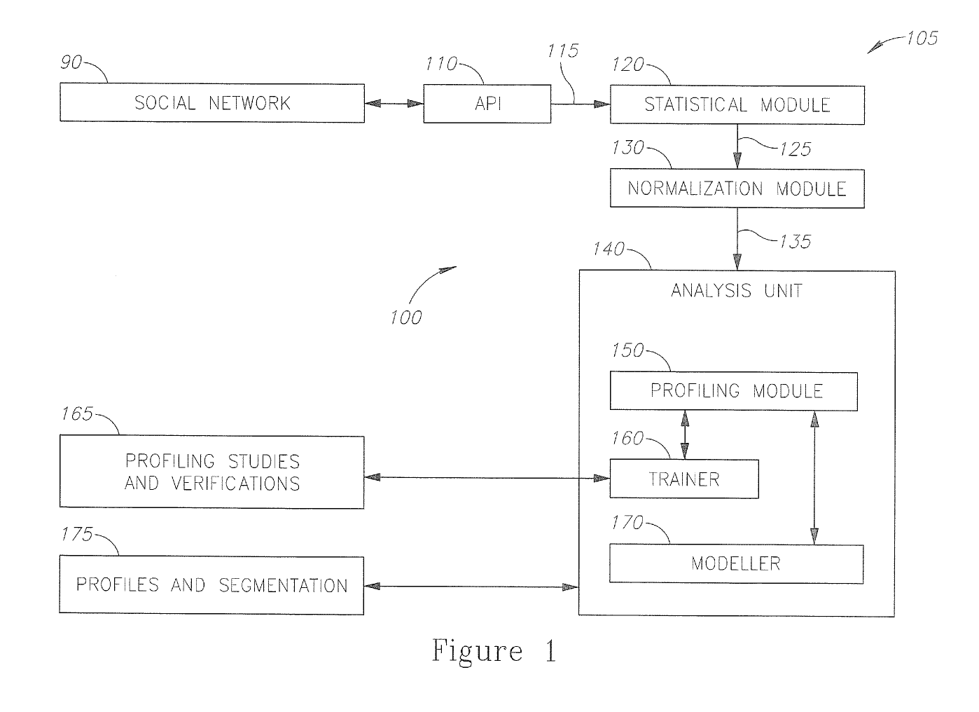

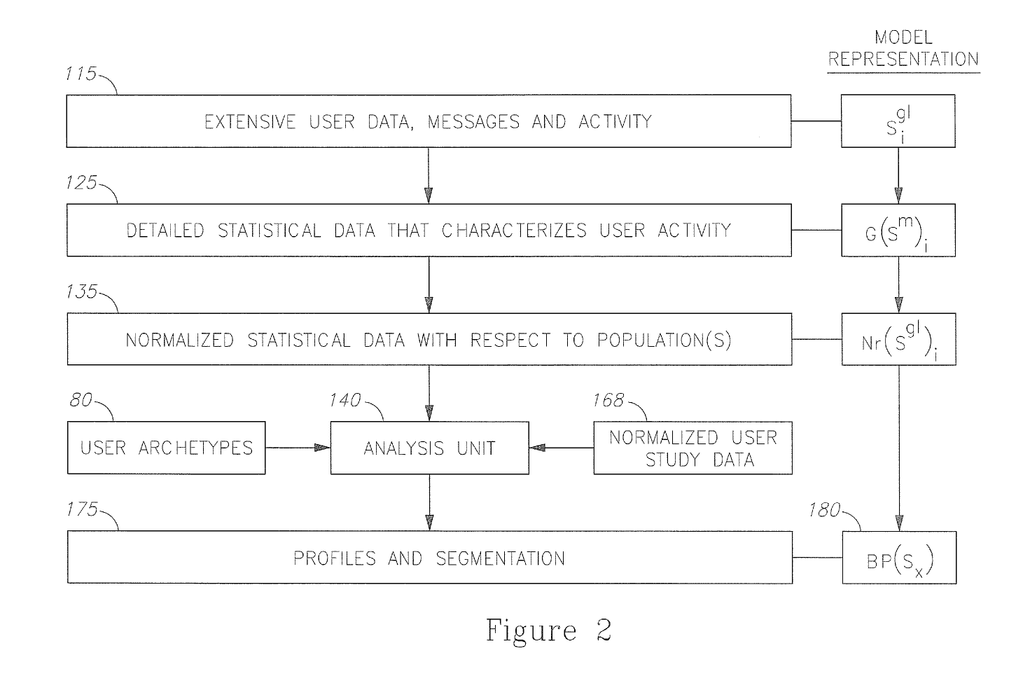

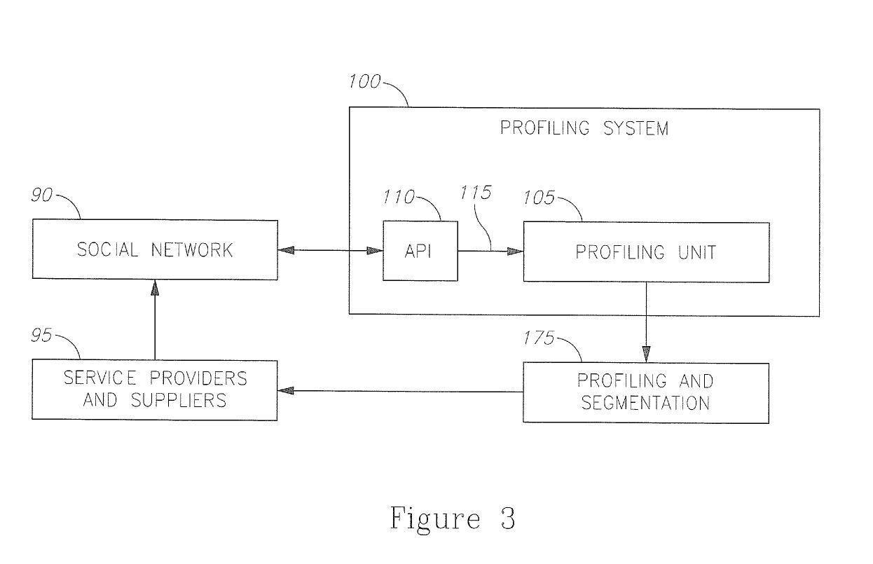

FIGS. 1-3 are high level schematic illustrations of a profiling system 100 according to some embodiments of the invention. FIGS. 1 and 3 are high level block diagrams while FIG. 2 illustrates the information flow through the system. Profiling system 100 may be at least partially implemented in computer hardware.

Profiling system 100 comprises a profiling unit 105 arranged to receive extensive user data 115, messages by users and user activities from various internet sources such as social networks 90, groups and forums and other sources, via an application programming interface (API) 110 which is dedicated to retrieve extensive data 115 from the relevant platforms. API 110 is also termed sniffer or super sniffer to denote its retrieval capabilities.

Profiling unit 105 comprises a statistical module 120, a normalization module 130 and an analysis unit 140, either of which may be at least partially implemented in computer hardware.

Statistical module 120 is arranged to receive user activity data 115 via API 110 and derive therefrom a plurality of statistical data 125 that characterize user activity data 115 with respect to a plurality of users, e.g., of social network 90. Statistical data 125 may be extensive and relate to various metrics, forms and ways of quantifying user activity data 115 such as counting messages, counting message lengths, assessing the vocabulary used, message complexity, number of corresponding users, duration of engagement in conversation, use of certain words or word categories, inter-relations between messages etc. See further details below.

In the model formalization, user activity data 115 is represented as Sᵢ^{gl} (FIG. 2). S is a basic discrete accumulated identifier. Examples for S comprise a wide range of parameters, for example, a number of messages for week, a number of friend request, a number of stated conversations, a number of published posts, and so forth. The index gl denotes the organic object current aggregation level. Examples of aggregation levels may comprise self-user, contact user, close environment, demographic environment, etc. The index i denotes the organic data entity instance. Examples or organic data entity instances may comprise specific monitored user, a specific contact user, etc.

In the model formalization, statistical data 125, also termed gross data, is represented as G(S^{m})ᵢ=Tₜ<G(S^{k . . . l})_{m . . . n}>. G(S) is a basic gross identifier. Examples of basic gross identifiers comprise e.g. daily average message per contact user, yearly engaged users, sum of received massages, average rate of conversation initializations etc. T represents a linear transformation type such as sum, average, count, variance, etc.

Normalization module 130 is arranged to receive and normalize statistical data 125 related to each user with respect to at least one user population to yield normalized statistical data 135 with respect to the population(s). The referred population may comprise all users of social network 90 or comprise sub-groups of users such as correspondents of each user, friends of the user, users having similar characteristics or similar to the user under specified rules etc. Normalization module 130 generates normalized statistical data 135 that characterizes each user and is simultaneously comparable between users due to its normalization.

In the model formalization, normalized statistical data 135 is represented as

$${Nr ( {S}^{gl} )}_{i} = fNr < {G ( {S}^{gl} )}_{i} , {T}_{var} < {G ( {S}^{gl + m} )}_{1. . k} > , {T}_{avg} < {G ( {S}^{gl + m} )}_{1. . k} >> m , k \geq 0$$

Nr(S) is a relative normalized gross identifier. Nr values are between 0 to 1 as they are normalized with respect to a whole population. The relative normalized gross identifiers represent the user's grade in each of his gross identifiers G(S), relative to his dynamic environment. m is an aggregation level indicator, wherein the selected level must be equal or greater than the current level).

Analysis unit 140 is arranged to analyze a correspondence between a plurality of normalized user study data 168 and a plurality of user archetypes 80. User archetypes 80 may be pre-defined according to socio-psychological criteria, and user study data 165 may be based on socio-psychological studies 165 such as profiling studies and verification studies which are externally managed to yield effective profiling and archetype analysis.

Analysis unit 140 is further arranged to associate, for each user, normalized statistical data 135 with one of user archetypes 80 according to the analyzed correspondence between normalized user study data 168 and user archetypes 80. The correspondence analysis yields profiling and segmentation data 175 of the users, which may be used for different aims such as advertising and e-commerce, that may be operated by various service providers and suppliers 95, optionally but not necessarily in relation of social network 90 from which user data have been collected.

In the model formalization, profiling and segmentation data 175 of the users is represented as Behavioral Pattern (BP) identifiers BP(Sₓ) 180. Examples for BP identifiers comprise, for example, practical, achiever, emotional, status seeker, popular, risk avoider, explorer, persistent, etc. x denotes a specific user instance.

Calculation of BP's 180 from normalized statistical data 135 represented as Nr's is carried out according to the following expression:

$${BP}_{x} = [ \frac{{\sum }_{i = 1}^{n} {ω}_{i} {Nr}_{i} - {\sum }_{j = n + 1}^{m} {ω}_{j} {Nr}_{j} + {\sum }_{j = n + 1}^{m} {ω}_{j}}{{\sum }_{k = 1}^{m + n} {ω}_{k}} + {\sum }_{d = 1}^{h} {ω}_{d} {Nr}_{d} * \frac{{ω}_{d}}{y} - {\sum }_{c = 1}^{l} {ω}_{c} {Nr}_{c} * \frac{{ω}_{c}}{y} ] \begin{matrix}1 \\ 0\end{matrix}$$

The symbols used denote: n—Number of positive effect vector parameters; h—Number of positive effect vector only parameters; m—Number of negative effect vector parameters; l—Number of negative only effect vector parameters; y—Fixed number which indicates the effect of a specific Nr on the formula and ωᵢ denote the weights.

The correspondence analysis may be carried out by applying a heuristic genetic algorithm (GA) on an artificial neural network (ANN) that represents the relation between normalized user study data 168 and user archetypes 80. Analysis unit 140 may comprise a modeller 170 arranged to represent normalized statistical data 135 as the artificial neural network, a profiling module 150 arranged to apply the heuristic genetic algorithm on the artificial neural network represented by modeller 170, and a trainer 160 arranged to train profiling module 150 with obtained normalized user study data. The analysis may be carried out by a profiling module 150 operating on an ANN model generate by a modeller 170. Normalized user study data 165 may be used to train the heuristic genetic algorithm via trainer 160.

The GA is a key feature which operates at the core of the behavioral identification technology to derive human personality analysis from online psycho-social behavior. The GA performs a behavioral psychological analysis of online communications and other interactions over time in order to identify and classify human behavior patterns. The GA is architecturally designed to operate independently from applicative layers and uses a broad data layer that is retrieved from social networks and is referred to as user activity data 115 representing social interactions data.

In embodiments, the social interactions data (user activity data 115) may be divided into four sub-layers. The first and basic one is the basic demographic layer (as explained), the next three micro-layers are composed of sophisticated formative gross data retrieved from the user's social interactions across the social network. Gross data (user activity data 115) is manipulated into various types of measures such as sums, averages, variances etc. to yield detailed statistical data that characterizes user activity 125. Detailed statistical data 125 is then normalized in comparison with the user's different environments and relationship circles: peer group, same gender same age group, close friends, all contacts etc. to yield normalized statistical data 135. This normalization process enables the GA to detect the relative location of the user on the scale of a specific behavior pattern and so forth to formulate his personality profile and clustering.

In embodiments, examples for social interactions data (user activity data 115) may comprise user's basic demographic information (such as the user's birth date, gender, place of residence, homeland, education, work etc.), interpersonal interaction data, public interaction and user to group interactions. The latter three examples are illustrated below in a non-limiting manner.

Interpersonal interaction is an interaction level which includes all relevant data that can be gathered from users' chats and/or offline messages. The GA collects the patterns and formative characteristics of correspondences which indicate the overall behavior pattern of the user's relationships and hence the user's personality across time and contacts. Gross interpersonal data may comprise data relating to relationships, conversations, messages, missed calls, sequences of messages, words, punctuation marks, chars repetition, common hours of interaction, initiation and duration of interaction, in addition to specific vocabulary. The activeness and conversation pattern of the user may be measured by comparison to his interlocutors.

Public interaction is an interaction level which comprises the user's public posts and/or public responses etc. Public interaction gross data may comprise statuses, photos, albums, shared links, comments, likes, statements of interests and hobbies, like indications, applications activity etc. Common measures of these data may comprise amount, frequency, length and category distribution. The user may be measured compared to his responders and/or other users discussing within the same post.

User to group interactions relate to analyzed user behavior in public circles which include his contacts users and outsider users. The GA gathers information regarding the user's “spreading the word” abilities distribution relativity, leading abilities relativity, frequency of user's contacts circle growth.

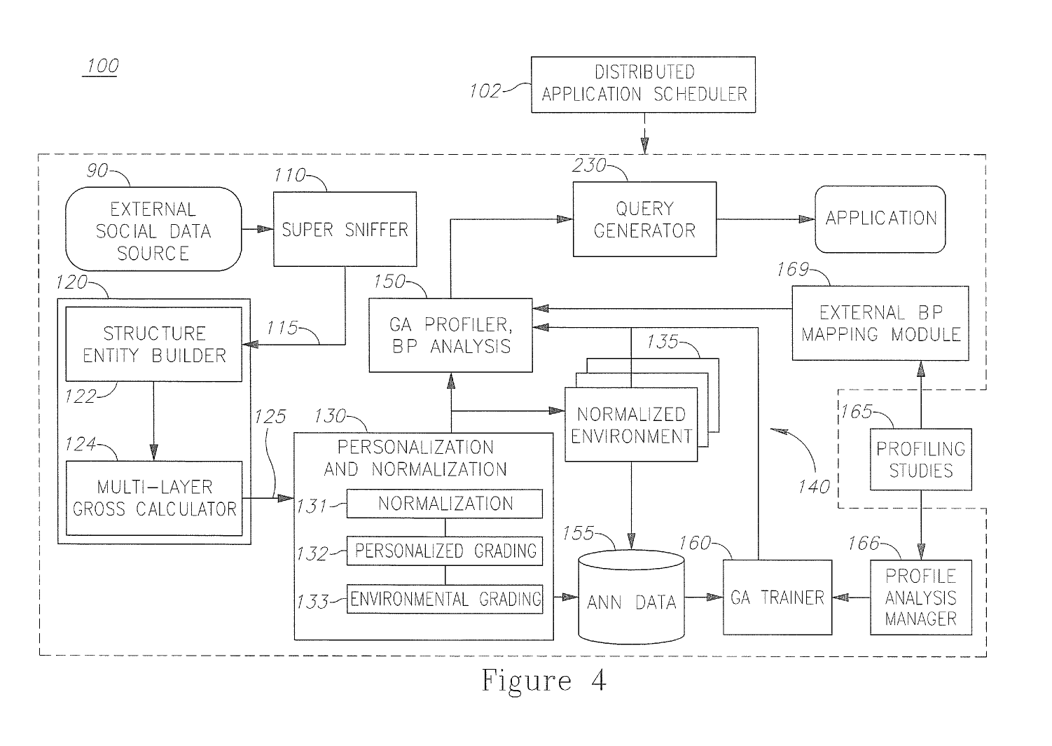

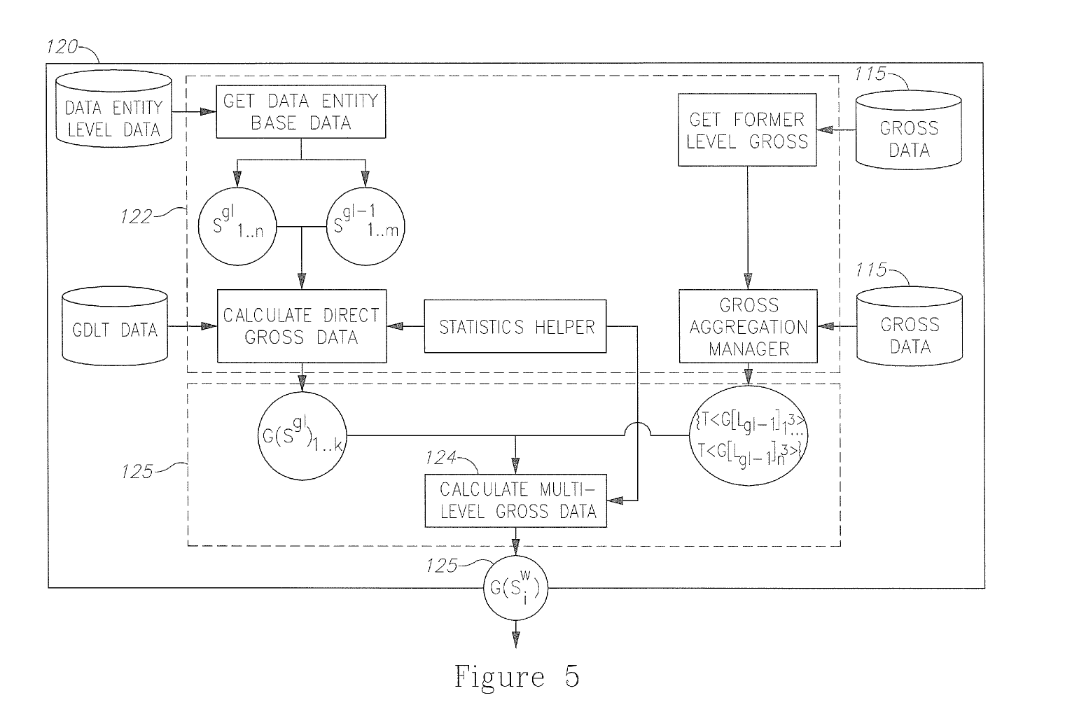

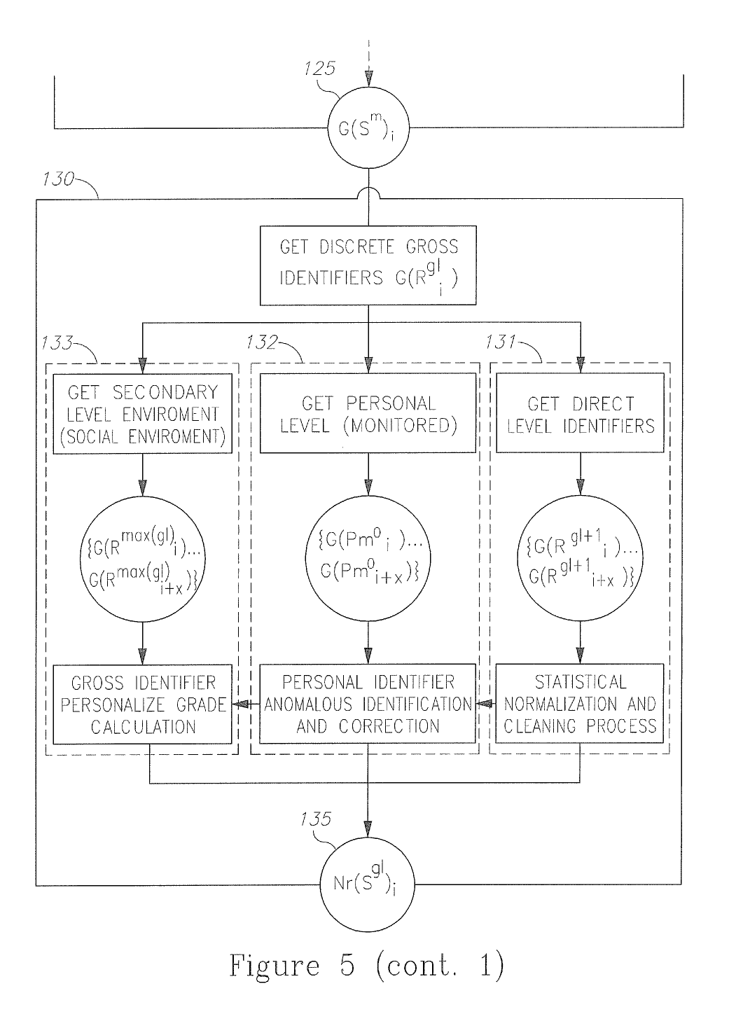

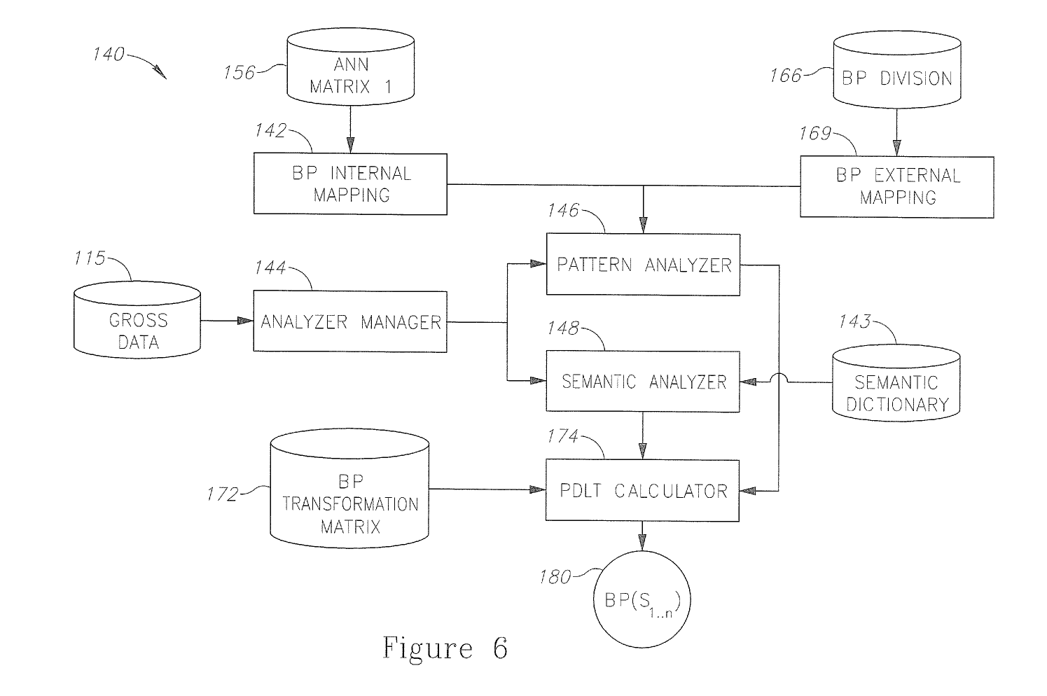

FIG. 4 is a high level schematic illustration of profiling system 100 according to some embodiments of the invention. FIG. 5 is a high level schematic flowchart illustrating a formalization of information flow through profiling system 100 according to some embodiments of the invention. FIG. 6 is a high level schematic illustration of profiling system 100 according to some embodiments of the invention.

Profiling system 100 may comprise a distributed applications scheduler 102, embodied, e.g., as a cloud based technology scheduling manager, which is responsible of timing the GA's different sub applications. The distributed applications scheduler main feature is running applications in parallel. It is being done by elastically allocating its resources among the applications according to their requirements during run time. Thus, combining smart load balancing engine and optimal resources distribution ensure smoothly applications operations.

FIG. 4 illustrates API 110 as a super sniffer engine that connects an external data source and profiling system 100 and gathers data 115 by demand. In certain embodiments, data 115 may be gathered by web pages crawling, XML/JSON parsing, connection with a given external social network API etc. Data 115 may then be organized and stored in a database to be provided to the structure entity building process operated by statistical module 120.

FIG. 4 illustrates statistical module 120 as comprising a structure entity builder 122 and a multi-layer gross calculator 124, also termed gross dynamic level transformation (GDLT) module. FIG. 5 further illustrates information modeling in statistical module 120, according to some embodiments of the invention.

In certain embodiments, structure entity builder 122 collects all the new raw data (115) stored in the database. By reviewing the data and performing comparisons with existing objects' data in the objects' hierarchy, structure entity builder 122 creates/updates a top-down full entities model and relationships. These new objects are then used in further analysis processes. Using the model representation, structure entity builder 122 constructs the basic discrete accumulated identifiers Sᵢ^{gl} from the raw data received from API 110 and then provides the data to multi-layer gross calculator 124 which constructs both basic gross data identifiers G(S^{gl})_{l . . . k} and the transformation types T.

Multi-layer gross calculator 124 (Gross Dynamic Level Transformation mechanism, GDLT) determined a correlation between each and every variable between data sub-levels (e.g., the four sub-layers illustrated above) and defines a list of transformation types. Multi-layer gross calculator 124 thus overcomes inter-layer data discrepancies. (The first stage in the GA's behavioral patterns calculation is reading the new data into the objects hierarchy and factorizing it into raw data which is used for simple mathematical aggregations. The aggregated gross identifiers are not completely correlated between the gross aggregation levels, a problem solved by the GDLT mechanism, see below) For instance, multi-layer gross calculator 124 may determine, with respect to user activity data 115, average aggregation (and variance included), normalized grading, down weighted average, up weighted average and other non-linear transformations, etc. These operations, including sub-layer integration yield detailed statistical data 125.

FIG. 4 illustrates normalization module 130 in its function of normalizing the aggregated data which was calculated by statistical module 120, according to some embodiments of the invention. The gross variables are being processed in a statistical analysis process termed gross personalization and normalization process. FIG. 5 further illustrates information modeling in normalization module 130, according to some embodiments of the invention.

This process may be carried out by three major modules: statistical normalization and cleaning module 131, gross variable personalized grade calculation module 132 and environmental normal grade calculation module 133.

Statistical normalization and cleaning module 131 is arranged to normalize, grade and clean gross data variables from specific noise interferences. The normalization may be conducted over the aggregated variables, by their source, lower levels' gross variables list.

Gross variable personalized grade calculation module 132 adjusts the gross variables to the objectives. These adjustments influence each of the gross variable values, according to the relation policy of the personalization definition table. The adjustments enable automatic learning of the user behavior pattern of the user himself in a dynamic environment. By that, all the measurements are internally identifying between different types of users and co-relationships.

Environmental normal grade calculation module 133 performs an adjustment to the wider society. This module perform grading adjustments by the related other changing layers and objects in the same environment (e.g., in normalized environments 135), by pre-defined comparison parameters such as socio-demography. By this ability, the GA can adjust its measurements to different cultures and widthwise dynamic behavior trends.

In certain embodiments, analysis unit 140 (e.g., GA profiler 150) generates profiles and segmentation 175 using the following psychological paradigm. A crucial phase in the relationship profiling process is the analyzed user object profile itself. Examples for profile parameters that are being collected for this object, meaning that the GA learns the user's personal behavior patterns: aggressiveness/passiveness, initiating habits, the way he or she co-responds to external engagements. The relationship parameters are generated for different data entity levels, time scopes and environments. The relationship parameters of a single product entity for instance, defines a time stamped position of the two parties in every relationship signature. Besides the immediate composition of these parameters, the GA internally stores the incline, trend line, and other derived instances.

The relationship parameters described above are composed from certain gross variables, arranged in a specific method. This closed group of gross variables is pre-defined in a GA-Trainer 160 by the supervised human-controlled process (in the ANN Matrix1 process). The building method of each relationship parameter is calculated in GA-Trainer 160 by the supervised process as stored in ANN Matrix1 156 (e.g., in an ANN database 155, and see FIG. 6).

GA Trainer 160 is responsible of improving the GA's calculation formulas. Given the personalization normalization and normalization environments data (ANN Data 155), GA Trainer 160 transforms the BP engine to an automated self-learning mechanism. GA Trainer 160 takes BP expected results combined with NR data in order to mutate new BP formulas. The new BP mutated formulas are created in order to improve GA's BP calculation results and reduce the MSE (Mean Square Error) of its results relatively to the expected results. Therefore, as new parameters are included in the BP formulas, GA Trainer 160 creates new mutations. These formula mutations guarantee a continuous, real time mechanism, which dynamically responds and improves the GA's calculations.

Using these relationships parameters and their widthwise relative grades, GA Profiler 150 maps the entire users' objects' psycho social personal patterns. Then, it can indicate the relative patterns in each sub-segment. The profile mapping method is actually a definition of the way that the different Nr parameters and their derived instances are joined together. As mentioned, there are many types of those variables, and their specific combination may be complex. For example: contradictive trends of Relation Level and Aggression Level of the analyzed user's entity, over time, may indicate a submission of one of the parties. The correlation between these mapping results and the actual reality states are determined by GA-Trainer 160. Then, the final step of the profiling process is one or more combinations (or relationship parameters mapping) that defines the specific behavioral parameter level.

GA Profiler 150 performs and analysis of Behavioral Pattern (BP) variables 180 which are the formal representation of user archetypes 80 (see FIG. 6 below). BP variables 180 represent specific human characteristics or sets of characteristics. GA Profiler 150 receives external profile data from profiling studies 165 via external BP mapping module 169. GA trainer 160 receives external profile data from profiling studies 165 via a profile analysis manager 166. Profile analysis manager 166 may comprise an automated self-learning module which is responsible of the BP's formulas composition. Based on past formulas and data, it chooses the best NR's and normalization environments in order to create formula which best fits each BP.

Results of GA Profiler 150 may be user to generate queries by a query calculator 230, for example query calculator 230 may be arranged to generate different behavior patterns categories. Therefore, it can point to which categories a BP relates. Consequently, category-BP segmentation level is created and is being used in broad category persona definition. Query calculator 230 may thus be used to segment users of an application such as a social network, for different purposes.

In certain embodiments, BP Variables 180 are composed by the following stages. GA Profiler 150 generates behavior pattern categories using the base variables, called BPs. Every BP is composed from a closed, pre-defined group of Nr variables (every Nr variable can be used for a couple of different BPs)—managed by an External BP Mapping Module 169 that receives profiling data from profiling studies 165.

There are several object levels that contain BP variables. A single BP can be produced by Nr variables from the same data-object, in lower levels, other BP variables, from the same object level but from lower a data-hierarchical order or any combination of them. The composition order of a BP variable is a dynamic value related combination.

The exact combination for each and every BP variable is determined using the ANN Trainer, and stored in the BP Composition Table—ANN Matrix1 155. The behavior pattern variable is defined by the following syntax: BP(S) i:
The ‘S’ stands for the definition of the source data entity.
The ‘cl’ stands for the definition of the current aggregation level.
The ‘i’ stands for the definition of the specific variable in that series.

The transition for each profile level is combined from two vectors—the direct lower profile data and its parallel (normalized) gross data level.

FIG. 6 is a high level schematic illustration of the behavior patterns building process, according to some embodiments of the invention.

In certain embodiments, analysis unit 140 generates an internal mapping 142 of BP variables 180 from ANN Matrix 155 and presents internal mapping 142 and BP external mapping 169 from BP modeling manager 166 (see FIG. 4) to a pattern analyzer 146. Pattern analyzer 146 is managed by analyzer manager 144 (may be part of profile analysis manager 166) that receives gross data 115 and controls a semantic analyzer 148 that uses a semantic dictionary 143. The pattern analysis and the semantic analysis, as well as BP transformation matrix 172 (exemplified above) are combined and inputted into a Profile Dynamic Level Transformation (PDLT) calculator 174 which derives BP variables 180.

In certain embodiments, BP variables derivation is carried out as follows. Profile variables (BPs) 180 are generated in dynamic transaction mechanisms.

The correlation between each and every variable between levels is determined by PDLT calculator 174. This mechanism defines a list of transformation types. Unlike the GDLT (for the gross variables), the PDLTs holds a definition of combination functions fBP that define the way to create each of the BP variables. The fBP is using a set of pre-defined transformation relations Tₜ< > (for the aggregative BPs) and a coefficient parameter for each organ.

In certain embodiments, profiling and segmentation data 175 of the users may be used for different aims such as advertising and e-commerce. For example, an advertisement managing unit may be arranged to generate advertisements relating to user archetypes 80 and a campaign managing unit may be arranged to present the generated advertisements to users of e.g. a social network platform according to their association with user archetypes 80. In another example, a proposal generator may be arranged to generate commercial proposals relating to user archetypes 80 and a commerce manager may be arranged to present the generated commercial proposals to users of e.g. a social network platform according to their association with user archetypes 80. The commerce manager may be further arranged to manage electronic commerce of the users in relation to their associated user archetypes 80.

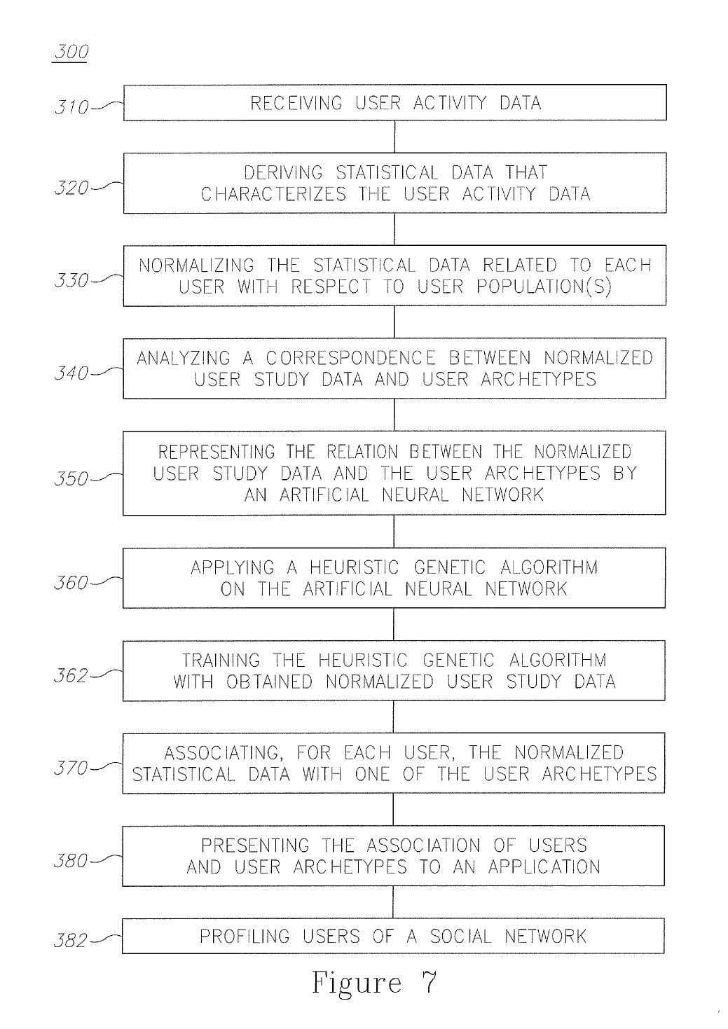

FIG. 7 is a high level schematic flowchart of a profiling method 300 according to some embodiments of the invention. At least one stage of method 300 is at least partially carried out by at least one computer processor.

Method 300 comprises the following stages: Receiving user activity data (stage 310); deriving statistical data that characterizes the user activity data (stage 320); normalizing the statistical data related to each user with respect to user population(s) (stage 330) and analyzing a correspondence between normalized user study data and user archetypes (stage 340).

Method 300 may further comprise representing the relation between the normalized user study data and the user archetypes by an artificial neural network (stage 350).

Analyzing the correspondence (stage 340) may comprise applying a heuristic genetic algorithm on the artificial neural network (stage 360); training the heuristic genetic algorithm with obtained normalized user study data (stage 362); and associating, for each user, the normalized statistical data with one of the user archetypes (stage 370).

Method 300 may further comprise presenting the association of users and user archetypes to an application (stage 380) and profiling users of a social network (stage 382).

Certain embodiments of the invention comprise a computer program product comprising a computer readable storage medium having computer readable program embodied therewith. The computer readable program may comprise computer readable program configured to implements any of the stages in method 300.

In certain embodiments, profiling system 100 may be used as an advertising management, targeting and media buying platform. Based on the behavioral psycho-social engine, profiling system 100 is arranged to provide a unique and simple way to plan, provision, and test and easily manage social networks Ads campaigns.

Advantageously, profiling system 100 and method 300 may be designed for the direct users' engagement layer, mainly on social platforms, using display ads from social inventory. Profiling system 100 and method 300 take different types of raw data from social networks and based on the unique analytical processes, accurately differentiates the users by analyzing their psycho-social behavioral pattern. Therefore, marketing messages can be more finely-tuned and personally directed to each psychological persona type.

In addition to the current social network methods of providing advertisers with obvious data such as user's interests, groups, geographical location and etc., profiling system 100 and method 300 further delve into yet another layer of user information that determines users' personalities. Profiling system 100 and method 300 accurately map valuable data from multi-layered virtual communication in social networks and create users' personal, archetypes-based customer profile. Advantageously, profiling system 100 and method 300 target the exact human profile user group for personalized user engagement and may split campaigns using an accurate users' clustering—reaching every different customer type with a designated, relevant advertising massage.

In the above description, an embodiment is an example or implementation of the invention. The various appearances of “one embodiment”, “an embodiment”, “certain embodiments” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Certain embodiments of the invention may include features from different embodiments disclosed above, and certain embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the an to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A profiling unit comprising:
a statistical module arranged to receive user activity data and derive therefrom a plurality of statistical data that characterize the user activity data with respect to a plurality of users;
a normalization module arranged to normalize the statistical data related to each user with respect to at least one user population; and
an analysis unit arranged to analyze a correspondence between a plurality of normalized user study data and a plurality of user archetypes, and to associate, for each user, the normalized statistical data with one of the user archetypes according to the analyzed correspondence,
wherein the correspondence analysis is carried out by applying a heuristic genetic algorithm on an artificial neural network that represents the relation between the normalized user study data and the user archetypes, and
wherein the profiling unit is at least partially implemented in computer hardware.

2. The profiling unit of claim 1, wherein the analysis unit comprises:
a modeller arranged to represent the normalized statistical data as the artificial neural network;
a profiling module arranged to apply the heuristic genetic algorithm on the artificial neural network represented by the modeller; and
a trainer arranged to train the profiling module with obtained normalized user study data.

3. The profiling unit of claim 1, wherein the user activity data comprises at least one of: user data, user messages and user activity, related to user activity in at least one of: at least one social network and at least one internet forum or group.

4. The profiling unit of claim 1, wherein the at least one user population comprises at least one of: all users, users within a group that is related to each user, correspondents of each user and users similar to each user under specified rules.

5. A profiling system comprising:
the profiling unit of claim 1;
an application interface to at least one social network platform arranged to obtain the user activity data therefrom and provide the obtained user activity data to the statistical module; and
a profiling interface arranged to present the association of users and user archetypes carried out by the analysis unit.

6. A profiling method comprising:
deriving, from obtained user activity data, a plurality of statistical data that characterizes the user activity data with respect to a plurality of users;
normalizing the statistical data related to each user with respect to at least one user population;
analyzing a correspondence between a plurality of normalized user study data and a plurality of user archetypes by applying a heuristic genetic algorithm on an artificial neural network that represents the relation between the normalized user study data and the user archetypes; and
associating, for each user, the normalized statistical data with one of the user archetypes according to the analyzed correspondence,
wherein at least one of: the deriving, the normalizing, the analyzing, the applying and the associating is carried out by at least one computer processor.

7. The method of claim 6, further comprising training the heuristic genetic algorithm with obtained normalized user study data.

8. The method of claim 6, further comprising presenting the association of users and user archetypes to an application.

9. A computer program product comprising a computer readable storage medium having computer readable program embodied therewith, the computer readable program comprising:
computer readable program configured to derive, from obtained user activity data, a plurality of statistical data that characterizes the user activity data with respect to a plurality of users;
computer readable program configured to normalize the statistical data related to each user with respect to at least one user population;
computer readable program configured to analyze a correspondence between a plurality of normalized user study data and a plurality of user archetypes by applying a heuristic genetic algorithm on an artificial neural network that represents the relation between the normalized user study data and the user archetypes; and
computer readable program configured to associate, for each user, the normalized statistical data with one of the user archetypes according to the analyzed correspondence.
